(19) United States
(12) Patent Application Publication
(10) Pub. No.: US 2024/0043010 A1
(43) Pub. Date: Feb. 8, 2024

(54) VEHICLE AND CONTROL METHOD FOR VEHICLE

(71) Applicant: TOYOTA JIDOSHA KABUSHIKI KAISHA, Toyota-shi (JP)

(72) Inventor: Hayato SHIRAI, Tagata-gun (JP)

(73) Assignee: TOYOTA JIDOSHA KABUSHIKI KAISHA, Toyota-shi (JP)

(21) Appl. No.: 18/365,167

(22) Filed: Aug. 3, 2023

(30) Foreign Application Priority Data
Aug. 4, 2022 (JP) 2022-124724

(51) Int. Cl. B60W 30/182; B60W 30/165; B60W 50/16

(52) U.S. Cl. CPC B60W 30/182; B60W 30/165; B60W 50/16; B60W 2050/0083

(57) ABSTRACT

A vehicle is provided with control device controlling a vehicle behavior for driver assistance or automated driving. The vehicle has, as driving modes at the time of driving, a first driving mode and a second driving mode by which an allowable range of the acceleration degree at the time of acceleration or deceleration is expanded at least at one of an upper limit side and lower limit side compared with the first driving mode. The control device is configured so as to set the driving mode to the second driving mode at the time of tracking making a host vehicle follow a tracked object at the time of driver assistance or the time of automated driving.

### CROSS-REFERENCE TO RELATED APPLICATION

This application claims priority to Japanese Patent Application No. 2022-124724 filed on Aug. 4, 2022, incorporated herein by reference in its entirety.

### FIELD

The present disclosure relates to a vehicle and a control method for a vehicle.

### BACKGROUND

Japanese Unexamined Patent Publication No. 5-141285 discloses a vehicle control device calculating a target following distance based on a vehicle speed for tracking for following a preceding vehicle and controlling acceleration and deceleration of a host vehicle.

### SUMMARY

If making a host vehicle track a preceding vehicle, it is possible to reduce the air resistance of the host vehicle. For this reason, it is possible to reduce the amount of energy consumed by the host vehicle (amount or fuel consumption or amount of power consumption) and increase the cruising distance of the host vehicle. The effect of reduction of the air resistance becomes lower the greater the following distance to the preceding vehicle. For this reason, when the following distance to the preceding vehicle has temporarily changed from a target following distance during tracking, if not able to quickly return the following distance to the target following distance, the effect of reduction of the air resistance due to the tracking is liable to become unable to be sufficiently obtained.

The present disclosure was made focusing on such a problem and has as its object to be able to quickly return the following distance to the target following distance when the following distance has temporarily changed from the target following distance during tracking.

To solve the above problem, a vehicle according to one aspect of the present disclosure is provided with a control device for controlling a vehicle behavior for driver assistance or automated driving and having, as a driving mode at the time of driving, a first driving mode and a second driving mode by which an allowable range of an acceleration degree at the time of acceleration or deceleration is expanded at least at one of an upper limit side and lower limit side compared with the first driving mode. The control device is configured so as to set the driving mode to the second driving mode at the time of tracking making a host vehicle follow a tracked object at the time of driver assistance or the time of automated driving.

Further, a control method for a vehicle having, as a driving mode at the time of driving, a first driving mode and a second driving mode by which an allowable range of an acceleration degree at the time of acceleration or deceleration is expanded at least at one of an upper limit side and lower limit side compared with the first driving mode, according to one aspect of the present disclosure, includes setting the driving mode to the second driving mode when tracking making a host vehicle follow a tracked object at the time of driver assistance or the time of automated driving.

According to these aspects of the present disclosure, when making a host vehicle run tracking a tracked object, the driving mode is set to the second driving mode with a broad allowable range of the acceleration degree at the time of acceleration or deceleration. For this reason, when the following distance temporarily changes from the target following distance, it is possible to accelerate or decelerate relatively strongly, so it is possible to quickly return the following distance to the target following distance.

### BRIEF DESCRIPTION OF DRAWINGS

FIG. 1 is a schematic view of the system configuration of a vehicle according to one embodiment of the present disclosure.

FIG. 2 is a flow chart for explaining processing for setting a driving mode according to one embodiment of the present disclosure.

### DESCRIPTION OF EMBODIMENTS

Below, referring to the drawings, embodiments will be explained in detail. Note that in the following explanation, similar constituent elements will be assigned the same reference numerals.

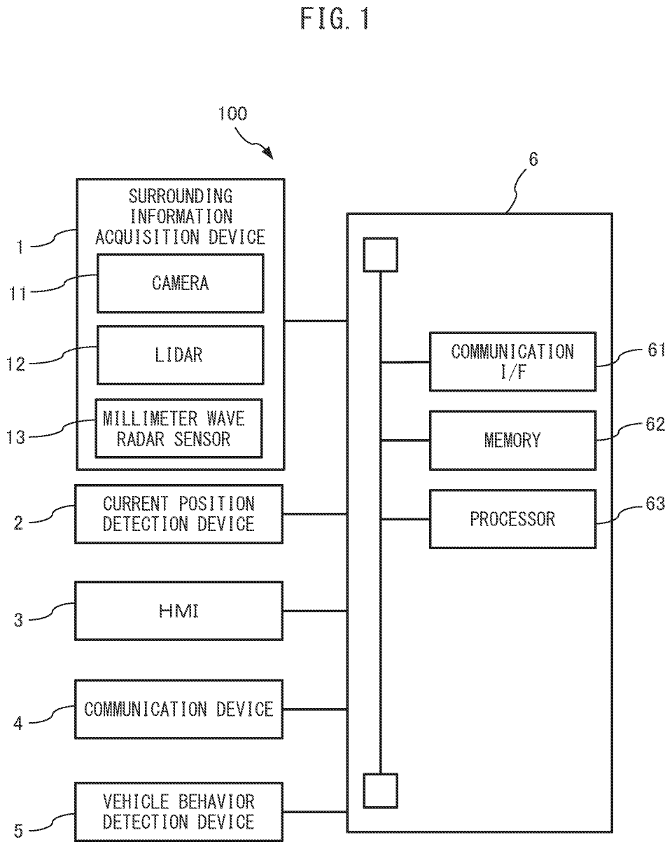

FIG. 1 is a schematic view of the system configuration of a vehicle 100 according to one embodiment of the present disclosure.

As shown in FIG. 1, the vehicle according to the present embodiment 100 is provided with a surrounding information acquisition device 1, current position detection device 2, human machine interface (below, referred to as the “HMI”), communication device 4, vehicle behavior detection device 5, and electronic control unit 6. The surrounding information acquisition device 1, current position detection device 2, HMI 3, communication device 4, and vehicle behavior detection device 5 are electrically connected through an internal vehicle network based on the CAN (controller area network) or other standard to the electronic control unit 6.

The surrounding information acquisition device 1 is a device for acquiring information relating to the surrounding environment of the host vehicle (below, referred to as the “vehicle surrounding information”). The vehicle surrounding information acquired by the surrounding information acquisition device 1 is sent through the internal vehicle network to the electronic control unit 6. The surrounding information acquisition device 1 can be comprised of one or more pieces of equipment. For example, it can be comprised of a camera, LIDAR (light detection and ranging device), millimeter wave radar sensor, ultrasonic sensor, etc.

In the present embodiment, as the surrounding information acquisition device 1, a camera 11 for capturing the surroundings of the host vehicle, a LIDAR 12 for using laser beams to detect objects such as other vehicles in the surroundings of the host vehicle, and a millimeter wave radar sensor 13 for detecting objects in the surroundings of the host vehicle over a far distance from the LIDAR 12 utilizing radio waves.

The current position detection device 2 is a device for detecting the position of the host vehicle (for example, the longitude and latitude of the vehicle). As the current position detection device 2, for example, a GNSS receiver for detecting the current position based on satellite signals received from a plurality of satellites etc. may be mentioned, but the disclosure is not limited to this. The vehicle current position detected by the current position detection device 2 is sent through the internal vehicle network to the electronic control unit 6.

The HMI 3 is an interface for inputting and outputting information between the vehicle 100 and its user (for example, driver or passengers, outside operator of vehicle, etc.) The HMI 3 is provided with an output device for outputting information to be provided to the vehicle user and an input device for the vehicle user to perform various input operations. As the output device, for example, a display or speaker, vibration unit, etc. may be mentioned. As the input device, for example, a touch panel or operating buttons, operating switches, microphone, etc. may be mentioned. The HMI 3 provides the output information received from the electronic control unit 6 through the internal vehicle network to the user of the vehicle through the output device. Further, the HMI 3 sends the input information input through the input device through the internal vehicle network to the electronic control unit 6.

Note that, the HMI 3 can be mounted in advance in the vehicle 100. Also, a terminal owned by the vehicle user (for example, a smart phone, tablet, PC, etc.) can be connected by a cable or wirelessly with the electronic control unit 6 and that terminal be made to function as the HMI 3.

In the present embodiment, to enable the vehicle behavior at the time of driving the vehicle to change, the electronic control unit 6 is able to set the driving mode of the vehicle 100 to any driving mode automatically or manually by the user of the vehicle through the HMI 3. Specifically, in the present embodiment, as the driving mode of the vehicle 100, any driving mode can be selected from among the two driving modes of at least the first driving mode and the second driving mode.

The first driving mode is, for example, a driving mode which prioritizes riding comfort or other comfort. In other words, the first driving mode is a driving mode in the allowable range of the acceleration degree at the time of acceleration or deceleration, which is limited to a relatively narrow range. The upper limit value of the allowable range (positive value) is the upper limit value of the acceleration degree allowed at the time of acceleration. The lower limit value of the allowable range (negative value) is the lower limit value of the acceleration degree allowed at the time of deceleration, in other words, the upper limit value of the deceleration degree allowed at the time of deceleration.

By limiting the allowable range of the acceleration degree at the time of acceleration or deceleration to a narrow range in this way, the vehicle is no longer accelerated by a large acceleration degree or decelerated by a large deceleration degree at the time of driver assistance or the time of automated driving, so it is possible to keep the riding comfort of the vehicle from deteriorating.

The second driving mode is, for example, a driving mode which prioritizes acceleration performance etc. and a driving mode by which the allowable range of the acceleration degree at the time of acceleration or deceleration is expanded compared with the first driving mode.

Due to this, by setting the driving mode to the second driving mode, when making a host vehicle track a preceding vehicle at the time of driver assistance or the time of automated driving, even if the preceding vehicle accelerates and the following distance to the preceding vehicle temporarily becomes larger than the target following distance, it is possible to accelerate with a large acceleration degree to quickly return the following distance to the target following distance. Further, when the preceding vehicle has decelerated as well, it is possible to decelerate with a large deceleration degree, so compared with the time of the first driving mode, it is possible to set the value of the target following distance to a small value.

The communication device 4 is a device for communicating with the outside of the vehicle. The communication device 4 is provided with a wide area communicator for communicating with the outside of the vehicle through a wireless communication network and a narrow area communicator for direct communication with terminals (for example, vehicle-to-vehicle, road-to-vehicle, and pedestrian-vehicle).

The vehicle behavior detection device 5 detects parameters showing the behavior of the vehicle 100 (below, referred to as the “vehicle behavior information”). The vehicle behavior information detected by the vehicle behavior detection device 5 is sent through the internal vehicle network to the electronic control unit 6. As the vehicle behavior detection device 5, for example, a vehicle speed sensor or acceleration degree sensor, steering angle sensor, etc. may be mentioned. As the vehicle behavior information, the vehicle speed, acceleration degree, steering angle, etc. detected by these sensors may be mentioned.

The electronic control unit 6 is provided with a communication interface (communication I/F) 61, memory 62, and processor 63.

The communication interface 61 is provided with an interface circuit for connecting the electronic control unit 6 to the internal vehicle network. The electronic control unit 6 is connected through the communication interface 61 to the above-mentioned surrounding information acquisition device 1 or other of the various vehicle-mounted equipment.

The memory 62 has an HDD (hard disk drive) or optical recording medium, semiconductor memory, or other storage medium. The memory 62 stores the various computer programs and data etc. used in the processor 63. Further, the memory 62 stores the data generated by computer programs, data received from various vehicle-mounted equipment through the communication interface 61, etc.

The processor 63 is provided with one or more CPUs (central processing unit) and their peripheral circuits. The processor 63 performs various processing based on various computer programs stored in the memory 62.

For example, the processor 63 prepares a driving plan of a host vehicle at the time of driver assistance or the time of automated driving based on the vehicle surrounding information, etc. and automatically performs driving operations relating to acceleration, steering, and braking in accordance with the driving plan so as to perform tracking following the preceding vehicle. As the tracking, adaptive cruise control (ACC) by which driving operations relating to acceleration and braking are automatically performed so that the following distance with the preceding vehicle is maintained constant, platooning by which driving operations relating to acceleration, steering, and braking are automatically performed so as to maintain the following distance with the preceding vehicle constant while enabling a lane change matching a lane change of a preceding vehicle or so as to track the preceding vehicle while matching the position of the preceding vehicle in the lane, etc. may be mentioned.

As explained above, by tracking, it is possible to reduce the air resistance of the host vehicle. As a result, it is possible to reduce the amount of energy consumed by the host vehicle (amount of fuel consumed or amount of power consumed) and increase the cruising distance of the host vehicle. In particular, by tracking the preceding vehicle while following the position of the preceding vehicle in the lane like with platooning (that is, by tracking the preceding vehicle while also controlling the vehicle behavior to the left and right in the lane), it is possible to more effectively reduce the air resistance of the host vehicle. Further, the effect of improvement of fuel economy due to this reduction of the air resistance tends to become higher when the following distance from the preceding vehicle is small compared to when it is large.

Therefore, during tracking, it is desirable to set the target following distance to the preceding vehicle to as small a distance as possible. However, the smaller the distance the target following distance to the preceding vehicle is made, the larger the deceleration degree of the deceleration has to be made so as to prevent collision when the preceding vehicle decelerates. Further, when the preceding vehicle accelerates and the following distance temporarily becomes larger than the target following distance, it is desirable to make the host vehicle quickly accelerate (that is, accelerate with a large acceleration degree) to return the following distance to the target following distance.

Therefore if, like in the present embodiment, enabling any driving mode to be selected and set from among the plurality of driving modes for changing the vehicle behavior at the time of driver assistance or at the time of automated driving, it is desirable to set the allowable range of the acceleration degree at the time of acceleration or deceleration during tracking to a broader driving mode.

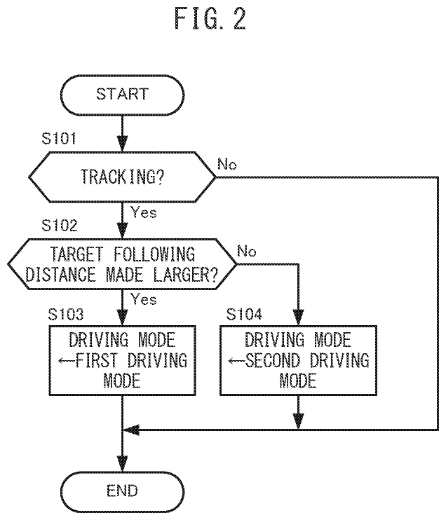

Therefore, in the present embodiment, during tracking, the driving mode was basically set to the second mode. Below, referring to FIG. 2, the content of the processing for setting the driving mode performed by the processor 63 and in turn the electronic control unit 6 for setting the driving mode to the second mode during tracking will be explained.

At step S101, the electronic control unit 6 judges whether tracking is being performed at the time of driver assistance or at the time of automated driving. If tracking is being performed, the electronic control unit proceeds to the processing of step S102. On the other hand, if tracking is not being performed, the electronic control unit 6 ends the current processing.

At step S102, the electronic control unit 6 judges whether the user of the host vehicle has increased the set value of the target following distance from the initial value through the HMI 3. Note that the initial value of the target following distance at the time of tracking is made the shortest following distance among the following distances which can be set. If the set value of the target following distance is made larger than the initial value, the electronic control unit 6 proceeds to the processing of step S103. On the other hand, if the set value of the target following distance is not made larger than the initial value, the electronic control unit 6 proceeds to the processing of step S104.

At step S103, the electronic control unit 6 sets the driving mode to the first driving mode. This is because it is believed that the set value of the target following distance being made larger than the initial value means that the user of the vehicle desires to drive with a higher comfort by securing a greater following distance.

At step S104, the electronic control unit 6 sets the driving mode to the second driving mode.

The vehicle according to the present embodiment explained above is provided with an electronic control unit 6 (control device) controlling a vehicle behavior for driver assistance or automated driving and has, as driving modes at the time of driving, a first driving mode and a second driving mode by which an allowable range of the acceleration degree at the time of acceleration or deceleration is expanded at least at one of an upper limit side and lower limit side compared with the first driving mode. Further, the electronic control unit 6 is configured so as to set the driving mode to the second driving mode at the time of tracking making a host vehicle follow a tracked object at the time of driver assistance or the time of automated driving.

In this way, according to the present embodiment, during tracking making a host vehicle follow a preceding vehicle (tracked object), the driving mode is set to the second driving mode with a greater allowable range of the acceleration degree at the time of acceleration or deceleration. For this reason, when the following distance temporarily changes from the target following distance, it is possible to accelerate or decelerate relatively strongly, so it is possible to quickly return the following distance to the target following distance.

Tracking, for example, is a mode for maintaining the following distance to the preceding vehicle (tracked object) at a predetermined target following distance while copying (tracing) the position of the preceding vehicle in the lane to follow the preceding vehicle. In the present embodiment, the target following distance at the time of tracking is made the shortest following distance among the following distances which can be set. Due to this, it is possible to more effectively reduce the air resistance of the host vehicle.

Further, in the present embodiment, the electronic control unit 6 is configured so that, if performing tracking at the time of driver assistance or the time of automated driving and the driving mode is set to the second driving mode, it changes the driving mode to the first driving mode when the user of the host vehicle increases the set value of the target following distance through the HMI 3 (information input device).

Due to this, if the user of a vehicle desires to drive with high comfort by securing a greater following distance, it is possible to perform tracking by a vehicle behavior along with the desire of the user of the vehicle.

Above, embodiments of the present disclosure were explained, but the above embodiments only show some of the examples of application of the present disclosure and are not intended to limit the technical scope of the present disclosure to the specific constitutions of the above embodiments.

For example, in the above embodiments, the computer program run in the electronic control unit 6 may also be provided in a form recorded in a computer readable portable recording medium such as a semiconductor memory, magnetic recording medium, or optical recording medium.

Further, in the above embodiments, the allowable range of the acceleration degree at the time of acceleration or deceleration of the second driving mode is expanded at both of the upper limit side and lower limit side compared with the first mode, but it is sufficient that the allowable range be expanded at least at one of the upper limit side and lower limit side compared with the first mode.

1. A vehicle comprising a control device configured so as to control a vehicle behavior for driver assistance or automated driving,
the vehicle having, as a driving mode at the time of driving, a first driving mode and a second driving mode by which an allowable range of an acceleration degree at the time of acceleration or deceleration is expanded at least at one of an upper limit side and lower limit side compared with the first driving mode,
the control device configured so as to set the driving mode to the second driving mode when tracking making a host vehicle follow a tracked object at the time of driver assistance or the time of automated driving.

2. The vehicle according to claim 1, wherein
the tracking is tracking for maintaining the following distance to the tracked object at a predetermined target following distance while copying the position of the tracked object in the lane so as to follow the tracked object.

3. The vehicle according to claim 2, wherein
the target following distance is made the shortest following distance among the following distances which can be set.

4. The vehicle according to claim 2, wherein
the control device is configured so that when tracking at the time of driver assistance or the time of automated driving and the driving mode is set to the second driving mode, it sets the driving mode to the first driving mode when the user of the host vehicle increases the set value of the target following distance through the information input device.

5. A control method for a vehicle having, as a driving mode at the time of driving, a first driving mode and a second driving mode by which an allowable range of an acceleration degree at the time of acceleration or deceleration is expanded at least at one of an upper limit side and lower limit side compared with the first driving mode, wherein
the control method includes setting the driving mode to the second driving mode when tracking making a host vehicle follow a tracked object at the time of driver assistance or the time of automated driving.
